(19) United States
(12) Patent Application Publication
(10) Pub. No.: US 2012/0218402 A1
(43) Pub. Date: Aug. 30, 2012

(54) COMPONENT PLACEMENT PROCESS AND APPARATUS

(75) Inventors: Koenraad A. Gieskes, Deposit, NY (US); Michael R. Vinson, Vestal, NY (US); Michael Yingling, Binghamton, NY (US)

(73) Assignee: UNIVERSAL INSTRUMENTS CORPORATION, CONKLIN, NY (US)

(21) Appl. No.: 13/033,789

(22) Filed: Feb. 24, 2011

(51) Int. Cl. H04N 7/18; G06T 7/00

(52) U.S. Cl. 348/87; 382/151; 348/E07.085

(57) ABSTRACT

A pick and place machine is described which uses an imprint left in a layer of fluid by a component that has been dipped in the fluid to guide a placement process. An apparatus for placing a component is disclosed, which includes a surface that receives a layer of fluid, an imprint of a component in the layer of fluid, and a camera that captures an image of the imprint in the fluid. A method of placing a component with a pick and place machine is disclosed which includes dipping a component in a layer of fluid, capturing an image of the layer of fluid, analyzing the image of the layer of fluid, and placing the component based on results of the analysis of the image of the layer of fluid. The image can be used to determine the status of the component or where to place the component.

### BACKGROUND OF THE INVENTION

1. Technical Field

The subject matter disclosed herein relates to component placement machines. More particularly, the subject matter relates to capturing the image of imprints in a fluid, and the usage thereof, during the placement cycle.

2. Background

The use of sophisticated component placement machines, also known as pick and place machines, in manufacturing printed circuits or similar cards, boards, panels, component packages and the like, is well known. The term printed circuit board (PCB) as used herein refers to any such electronic packaging structure. Typically, components are supplied to the placement machine by a variety of feeders. Examples of feeders include tape feeders which hold one or more reels of components, matrix feeders which hold one or more pallets of components, and wafer feeders which hold one or more wafers of dies. All of these feeders provide components at a pick station, where the pick station is a part of the pick and place machine. One or more pick and place heads, each pick and place head having a vacuum spindle equipped with a nozzle, picks up a component from a pick station. The pick and place head may be moved in the X and Y axes in a plane above the pick station and the PCB being populated. Each vacuum spindle may be moved in the Z-axis (i.e., in and out from an extended to a retracted position). Each nozzle is sized and otherwise configured for use with different sizes and styles of component to be placed by the machine.

In operation, the pick and place head is moved to the feeder pick station and the nozzle of the pick and place head is positioned over the component. The nozzle is lowered (i.e., extended), via its associated vacuum spindle to a point where, upon application of vacuum, the component is removed from the feeder and held tightly against the vacuum nozzle orifice. The pick and place head is then moved to a point over the PCB being assembled. The vacuum spindle is then lowered and the component is deposited on the PCB at a predetermined location.

It is often desirable to capture an image of the component prior to placing the component on the PCB. Capturing an image of the component is performed to increase the efficiency of the placement process. It is more cost effective to determine if there is a problem with the component as the component is being placed than to find the problem after placement of the component on a substrate. When an image of the component is to be captured, after picking the component, the pick and place head may move to an upward looking camera where an image of the bottom of the component is captured. Alternatively, a camera may be contiguous with the pick and place head, such that an image of the component may be acquired while the pick and place head is moved to the placement location. In either case, the acquired image is processed to determine a presence, size, and position on the nozzle of the component. For leaded, flip chip or packaged components the image may also be analyzed for the position and angles of the leads or bumps as well as missing leads or bumps and lead or bump-size deviation.

For some processes a component may need to have a fluid, such as flux, an adhesive, solder paste or the like, applied prior to placement of the component on the printed circuit board or substrate. In this case, after capturing an image of the component as explained above, the pick and place head will move to a fluid application station located in the machine, where the pick and place head will extend the spindle such that the fluid is applied to the bottom of the component. Once the fluid is applied, the spindle is raised. If required, another image of the component may be captured to verify that all the leads or bumps have fluid applied or to ensure that the component is not left at the fluid application station in the often sticky layer of fluid. The pick and place head is then moved to the printed circuit board.

The above described process of move, pick, move, capture image, move, apply fluid, move and place can be very timing consuming, especially if the component needs to be re-imaged after the fluid has been applied. These extra moves between picking and placing a component result in a lower placement machine throughput. It is desirable to have a pick and place machine and a pick and place process which minimizes the time it takes to place a component without increasing the number of errors that occur in the placement process.

### DISCLOSURE OF THE INVENTION

The present invention relates to component placement machines. More particularly, the subject matter relates to capturing the image of imprints in a fluid, and the usage thereof, during the placement cycle.

Disclosed is an apparatus for capturing an image of a layer of fluid in a pick and place machine. The apparatus includes a surface which receives a layer of fluid, and an imprint of a component in the layer of fluid. The imprint of the component is formed in the layer of fluid after a pick and place head dips the component in the layer of fluid. The apparatus according to the invention also includes a camera positioned to capture an image of the imprint in the layer of fluid. In some embodiments the camera is positioned to capture an image of a top side of the imprint in the layer of fluid. In some embodiments the camera is positioned to capture an image of a bottom side of the imprint in the layer of fluid. In some embodiments the apparatus includes a light source which illuminates the imprint in the layer of fluid. In some embodiments the apparatus includes a processor for analyzing the image of the imprint in the layer of fluid.

Disclosed is a pick and place machine which includes an image of a layer of fluid. The image of the layer of fluid is used to guide the placement of a component that is being placed with the pick and place machine. In some embodiments the image of the layer of fluid is an image of an imprint that has been left in the layer of fluid after a component has been dipped in the layer of fluid. The image of the layer of fluid is analyzed to obtain information about the component or about the pick and place machine. In some embodiments the image is used to determine where to place the component. In some embodiments the image is used to determine the status of the component. In some embodiments the image is used to determine the alignment status of the pick and place machine.

Disclosed is a method of placing a component with a pick and place machine that includes dipping a component in a layer of fluid, capturing an image of the layer of fluid, analyzing the image of the layer of fluid, and placing the component, wherein the component is placed based on results of the analysis of the image of the layer of fluid. In some embodiments capturing an image of the layer of fluid includes capturing an image of an imprint of the component in the layer of fluid, where the imprint of the component resides in the layer of fluid after the component is dipped in the layer of fluid. In some embodiments capturing an image of the layer of fluid includes capturing an image of a top side of the layer of fluid. In some embodiments capturing an image of the layer of fluid includes capturing an image of a bottom side of the layer of fluid. In some embodiments capturing an image of the layer of fluid includes capturing an image of a top side and capturing an image of a bottom side of the layer of fluid. In some embodiments placing the component includes placing the component where it will be discarded, based on results of the analysis of the image of the layer of fluid. In some embodiments analyzing the layer of fluid includes determining that fluid was not properly transferred to the component based on results of the analysis of the image of the layer of fluid. In some embodiments the method includes determining the alignment status of the pick and place machine using the image of the layer of fluid. In some embodiments determining the alignment status of the pick and place machine includes measuring an amount of alignment shift present in a pick and place head using the image of the layer of fluid, and applying the amount of alignment shift to subsequent movement of the pick and place head.

Disclosed is a method of determining the status of a component in a pick and place machine including dipping a component in a layer of fluid, capturing one or more than one image of the layer of fluid, and determining the status of the component based on an analysis of the one or more than one image of the layer of fluid. In some embodiments determining the status of the component based on an analysis of the one or more than one image of the layer of fluid include determining that the component is misaligned on a pick and place head by a misalignment amount based on an analysis of the one or more than one image of the layer of fluid, and adjusting the alignment of the pick and place head by the misalignment amount. In some embodiments determining the status of the component based on an analysis of the one or more than one image of the layer of fluid includes determining that the component is properly placed on the end of a pick and place head based on an analysis of the one or more than one image of the layer of fluid. In some embodiments determining the status of the component based on an analysis of the one or more than one image of the layer of fluid includes determining that fluid was not properly transferred to the component based on an analysis of the one or more than one image of the layer of fluid. In some embodiments the method includes determining the alignment status of the pick and place machine based on an analysis of the one or more than one image of the layer of fluid. In some embodiments determining the alignment status of the pick and place machine based on an analysis of the one or more than one image of the layer of fluid includes comparing an image of a top side of the layer of fluid to an image of a bottom side of the layer of fluid.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 shows a top elevational view of component placement machine 100.

FIG. 2A shows a top view of component 800 prior to being dipped in fluid.

FIG. 2B shows a side view of component 800 prior to being dipped in fluid.

FIG. 2C shows a bottom view of component 800 prior to being dipped in fluid.

FIG. 3 depicts a side view of component 800 at fluid application station of machine 100 of FIG. 1 prior to component 800 being dipped in layer of fluid 720.

FIG. 4 depicts a side view of component 800 at fluid application station of machine 100 of FIG. 1 showing component 800 being dipped in layer of fluid 720.

FIG. 5 depicts a side view of component 800 at fluid application station of machine 100 of FIG. 1 showing component 800 after being dipped in layer of fluid 720. Apparatus 150 according to the invention is shown, where apparatus 150 includes surface 710, imprint 740 in layer of fluid 720, and camera 730.

FIG. 6A shows a bottom view of component 800 after component 800 has been dipped in layer of fluid 720.

FIG. 6B shows image 732 of layer of fluid 720, where image 732 includes imprint 740 of component 800 of FIG. 6A after component 800 has been dipped in layer of fluid 720.

FIG. 7A shows a side view of component 800 with missing bump 850 prior to being dipped in layer of fluid 720.

FIG. 7B shows a side view of component 800 with missing bump 850 of FIG. 7A after being dipped in layer of fluid 720.

FIG. 7C shows a bottom view of component 800 with missing bump 850 of FIG. 7A after being dipped in layer of fluid 720.

FIG. 7D shows image 732 where image 732 is an image of layer of fluid 720 after component 800 with missing bump 850 of FIG. 7A has been dipped in layer of fluid 720, showing void 750 from missing bump 850.

FIG. 8A shows a side view of component 800 prior to being dipped in layer of fluid 720.

FIG. 8B shows a side view of component 800 of FIG. 8A after being dipped in layer of fluid 720, showing bump 852 which did not have fluid adhere to it.

FIG. 8C shows a bottom view of component 800 of FIG. 8A after being dipped in layer of fluid 720, with bump 852 that does not have fluid adhered to it.

FIG. 8D shows image 732 where image 732 is an image of layer of fluid 720 after component 800 of FIG. 8A has been dipped in layer of fluid 720, showing void 750 from bump 852 missing fluid.

FIG. 9A shows a side view of component 800 prior to being dipped in layer of fluid 720, where component 800 has rotated or skewed bumps 810.

FIG. 9B shows a side view of component 800 of FIG. 9A with rotated bumps 810 after being dipped in layer of fluid 720.

FIG. 9C shows a bottom view of component 800 of FIG. 9A with rotated bumps after being dipped in layer of fluid 720.

FIG. 9D shows image 732 where image 732 is an image of layer of fluid 720 after component 800 of FIG. 9A with rotated bumps 810 has been dipped in layer of fluid 720, showing rotated imprint 740 of bumps 810.

FIG. 10A shows a side view of component 800 prior to being dipped in layer of fluid 720, where component 800 has a shifted bump 854.

FIG. 10B shows a side view of component 800 of FIG. 10A with shifted bump 854, after being dipped in layer of fluid 720.

FIG. 10C shows a bottom view of component 800 of FIG. 10A with shifted bump 854, after being dipped in layer of fluid 720.

FIG. 10D shows image 732 where image 732 is an image of layer of fluid 720 after component 800 of FIG. 10A with shifted bump 854 has been dipped in layer of fluid 720, showing imprint 754 of shifted bump 854.

FIG. 11 shows another embodiment of apparatus 150 according to the invention, where apparatus 150 includes two cameras, downward looking camera 500 and upward looking camera 730, surface 710, and imprint 740 in layer of fluid 720.

FIG. 12A shows image 502, where image 502 is an image of imprint 720 as taken with downward looking camera 500 of FIG. 11, where no thermal shift has occurred.

FIG. 12B shows image 732, where image 502 is an image of imprint 720 as taken with upward looking camera 730 of FIG. 11, where no thermal shift has occurred.

FIG. 13A shows image 502, where image 502 is an image of imprint 720 as taken with downward looking camera 500 of FIG. 11, where thermal shift of pick and place machine 100 has occurred.

FIG. 13B shows image 732, where image 502 is an image of imprint 720 as taken with upward looking camera 730 of FIG. 11, where thermal shift of pick and place machine 100 has occurred.

FIG. 14 shows another embodiment of apparatus 150 according to the invention, where apparatus 150 includes downward looking camera 500, light source 780, surface 710, and imprint 740 in layer of fluid 720.

FIG. 15 illustrates method 840 of placing a component with a pick and place machine according to the invention.

FIG. 16 illustrates method 860 of determining the status of a component in a pick and place machine according to the invention.

FIG. 17A depicts a simplified flow diagram of a method of placing a component according to the prior art.

FIG. 17B shows a flow chart of a method of placing a component with a pick and place machine according to the invention.

FIG. 18 shows a flow chart of another method of placing a component with a pick and place machine according to the invention.

FIG. 18 shows a flow chart of a further method of placing a component with a pick and place machine according to the invention.

### DETAILED DESCRIPTION OF EMBODIMENTS OF THE INVENTION

A detailed description of the hereinafter described embodiments of the disclosed apparatus and method are presented herein by way of exemplification and not by way of limitation with reference to the Figures.

Described herein is a new process of placing a component which eliminates one and sometimes two or more travels of the pick and place head to a camera, thus saving time and making the placement process faster, which in turn increases the output of the component place machine and lowers the cost per placement. This new process will provide reliable information about deviations in component, lead or bump size and the absence/presence of fluid on each lead or bump, which is important to the reliability of the electrical connection of the component to the printed circuit board or substrate and thus to the quality of the product. The new process and apparatus uses an imprint of the component in a layer of fluid to reduce steps and provide information on the component during the pick and place process. A pick and place process often includes dipping a component in a layer of fluid. The fluid often has a high viscosity, such that after the component is removed from the fluid, an imprint of the component is left in the fluid. It has been discovered that information about the component and about the pick and place machine can be obtained from the imprint of the component in the layer of fluid. Described herein is a process and apparatus that uses a captured image of the imprint of a component in a layer of fluid to speed the placement process of the component and increase the efficiency and/or quality of the process.

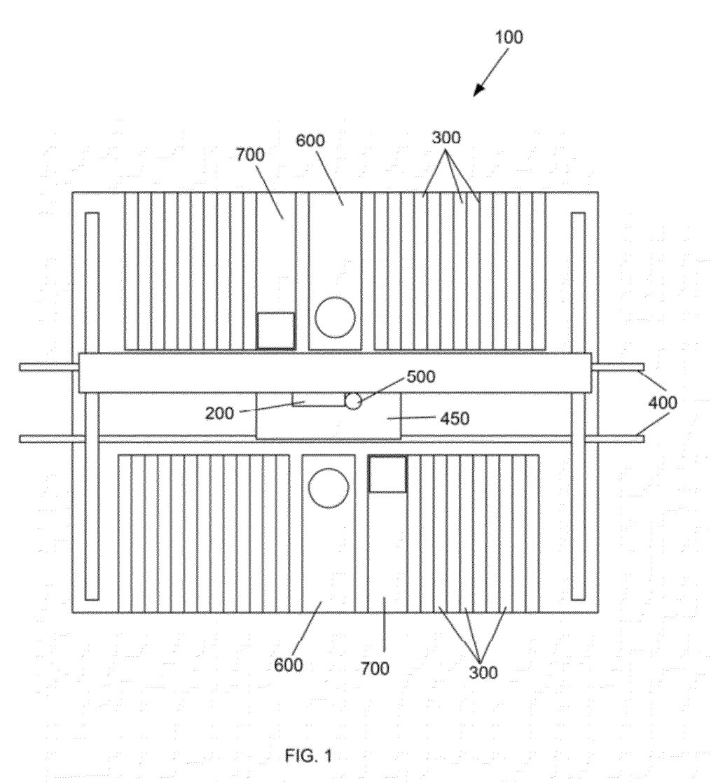

Referring to FIG. 1, shown is a component placement machine 100, also known as pick and place machine 100 or machine 100. Particularly, FIG. 1 shows a top elevational view of pick and place machine 100. Machine 100 in this embodiment includes one or more pick and place heads 200, a plurality of feeders 300, board handling system 400 upon which a component receiver such as a printed circuit board or substrate 450 is located, one or more downward looking cameras 500, one or more upward looking cameras 600, and one or more fluid application stations 700. Pick and place machines (component placement machines) 100 have different configurations as is known in the art. The disclosed process and apparatus according to the invention can be used with many different types or models of pick and place machines and is not limited to those shown in the figures. Pick and place machines, such as pick and place machine 100 as shown in FIG. 1, are used to pick up a component with pick and place head 200, move the component to one or more different locations, and place the component, often performing different actions with or on the component along the way. The component receiver is referred to in the figures as substrate 450, but a component can be placed according to the invention on any type of component receiver. The disclosed process and apparatus can be used to place components on any type of substrate, printed circuit board, module, package, or other type of component receiver.

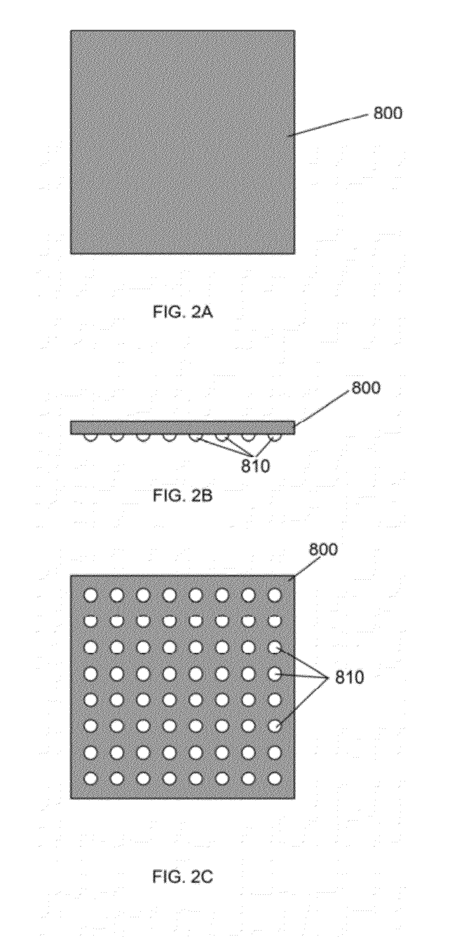

FIG. 2A through FIG. 2C shows an example of a component 800 which can be operated on by pick and place machine 100. In this embodiment component 800 is a flip chip or packaged component 800 with interconnect elements 810 on one side of component 800. FIG. 2A shows a top elevational view of component 800, FIG. 2B shows a side view of component 800, and FIG. 2C shows a bottom view of component 800. Components 800 often comprise a pattern of interconnect elements 810 on one side. In this embodiment component 800 includes bumps 810 on the bottom side of component 800. Although the component illustrated here comprises bumps as interconnect elements 810, other components, both leaded and leadless, and other interconnect elements 810, where interconnects 810 may extend from other portions of component 800, may be used with the apparatus and process according to the invention. The process and apparatus according to the invention can be used on many different components, and is not limited to use on bumped components as shown in the figures. Some embodiments of the process and apparatus according to the invention operate on leaded electronic components, some on printed circuit board components or printed circuit boards themselves. Some embodiments of the process and apparatus according to the invention operate on mechanical components. The process and apparatus according to the invention is not limited to operation on any type, size or configuration of component; or with any type, size, or configuration of interconnect elements 810 on component 800.

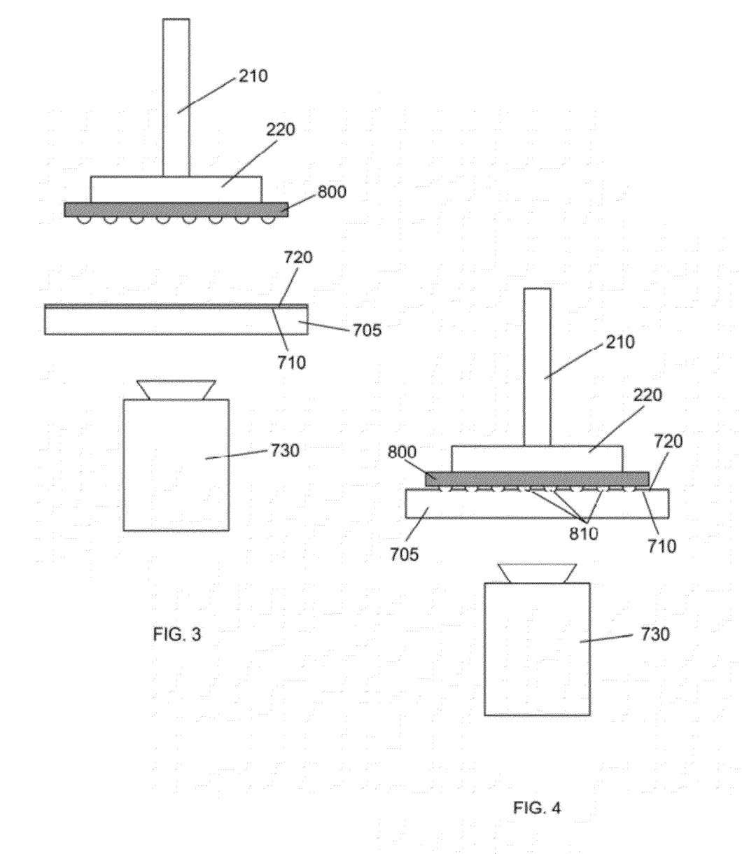

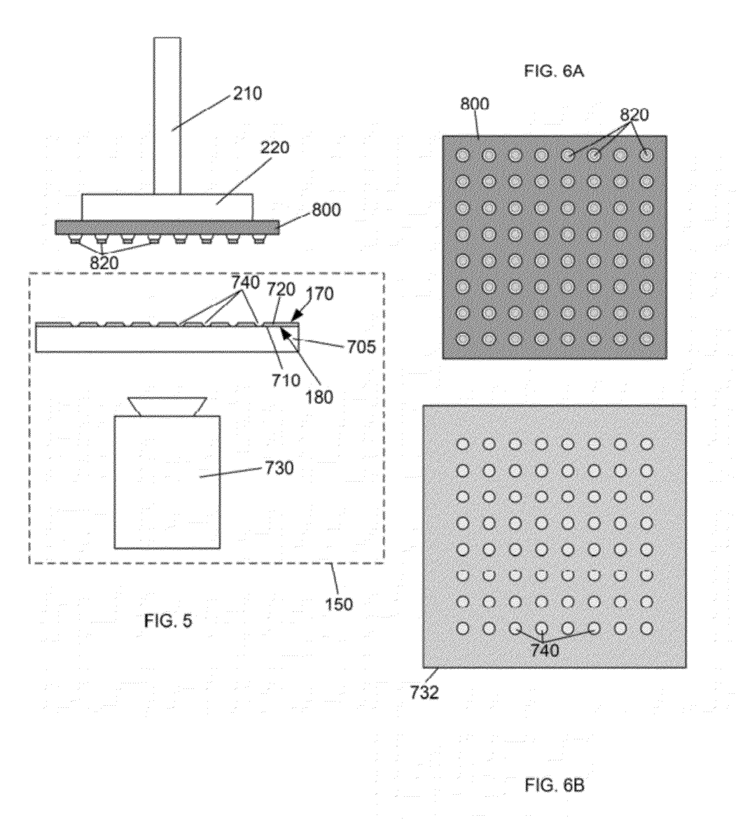

FIG. 3 through FIG. 5 shows pick and place head vacuum spindle 210, which is part of pick and place head 200 of machine 100 as shown in FIG. 1. Each pick and place head 200 may include one or more vacuum spindles 210 with a nozzle 220 at a distal end. Vacuum spindle 210 of each pick and place head 200 is movable along a Z-axis between an extended position and a retracted position, such as in FIG. 3 where vacuum spindle 210 is in the retracted position. FIG. 4 shows vacuum spindle 210 in the extended position, and FIG. 5 shows vacuum spindle 210 that has been moved back to the retracted position. In its extended position, nozzle 220 may pick up component 800 at feeder 300 and/or place component 800 on substrate 450. Pick and place head 200 is movable in an X-Y plane, thereby allowing movement between feeders 300 and substrate 450, and as needed to upward looking cameras 600 and/or fluid application stations 700.

FIG. 3 through FIG. 5 shows vacuum spindle 210 with component 800 at fluid application station 700. Often prior to placement, components 800 require the application of a fluid to interconnect elements 810. This fluid can be any fluid, for example adhesive, solder paste, flux, or other fluid. Fluid application is often accomplished by dipping bumps 810 of component 800 into a fluid at fluid application station 700. In this example, component placement machine 100 is equipped with fluid application station 700, in this case a thin film applicator (TFA). The TFA typically uses a doctor blade technology to produces layer of fluid 720 approximately half the thickness of bumps 810 on surface 710 of plate 705, by either moving the blade over surface 710, or by moving surface 710 underneath a stationary blade. Plate 705 may be made from a variety of materials, but for the purposes of this embodiment, the material is transparent. In some embodiments plate 705 is made from material that is not transparent. In this embodiment layer of fluid 720 prior to component 800 being dipped is level (FIG. 3), then component 800 is lowered into layer of fluid 720 until bumps 810 contact surface 710 (FIG. 4). This process applies the right amount of fluid onto each bump 810. In this embodiment layer of fluid 720 is a solder paste, and dipping bumps 810 into layer of fluid 720 enables a reliable soldering process. Component 800 is then raised (FIG. 5) leaving voids or an imprint 740 in layer of fluid 720. In the case of a leaded component, the leads would leave an imprint and in case of a leadless component, imprint 740 would be that of the component itself. Bumps 810 from FIG. 3 have become bumps 820 in FIG. 5, where bumps 820 are a bump 810 with an amount of fluid on them.

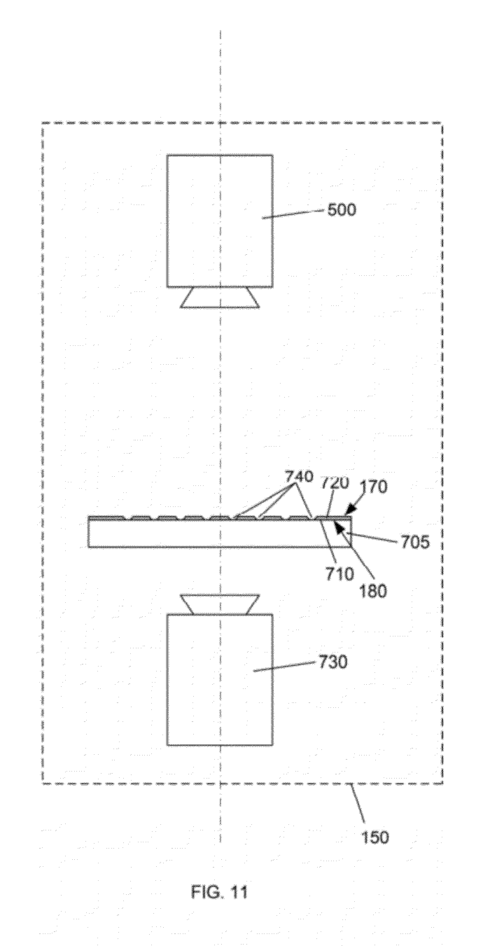

As shown in FIG. 3 through FIG. 5, fluid application station 700 may further comprise an upward looking camera 730 which may either be stationary or moveable underneath plate 705. FIG. 5 shows apparatus 150 for capturing an image of a layer of fluid in pick and place machine 100. Apparatus 150 includes surface 710, imprint 740 in layer of fluid 720, and camera 730 and/or camera 500 (see FIG. 11). Surface 710 receives layer of fluid 720. Imprint 740 of component 800 is left in layer of fluid 720 after pick and place head 200 has dipped component 800 in layer of fluid 720. Upward looking camera 730 is positioned to capture an image 732 (see FIG. 6) of imprint 740 that resides in layer of fluid 720. In some embodiments camera 730 or camera 500 captures image 732 of imprint 740 in layer of fluid 720 after component 800 has been dipped in layer of fluid 720. In some embodiments camera 730 or camera 500 captures image 732 of imprint 740 in layer of fluid 720 while component 800 is still dipped in layer of fluid 720. A vision system with a processor (not shown) can process image 732 of imprint 740 and reliably present results for position, angle, missing leads or bumps, lead or bump size deviation and components left sticking in the fluid 720. Pick and place machine 100 therefore includes apparatus 150, where apparatus 150 includes imprint 740 in layer of fluid 720. Image 732 of imprint 740 in layer of fluid 720 is used to guide pick and place machine 100 in placing component 800. In this embodiment image 732 is an image of imprint 740 of component 800 that was dipped in layer of fluid 720. Image 732 can be analyzed to determine the status of component 800, including where component 800 is to be placed. Image 732 can be used in many different ways to improve the throughput and accuracy of pick and place machine 100. Pick and place machine 100 with apparatus 150 can place component 800 based on the results of an analysis of image 732 of imprint 740 in layer of fluid 720. Pick and place machine 100 including apparatus 150 can use image 732 to determine the status of component 800, including whether component 800 is properly positioned, is in possession of all of its interconnect elements, and whether the interconnect elements have had fluid applied.

In the embodiment of apparatus 150 as shown in FIG. 5, layer of fluid 720 is placed on surface 710, where surface 710 in this embodiment is part of a flat plate 705. Surface 710 according to the invention does not have to be a part of a plate and does not have to be flat. In some embodiments of apparatus 150 surface 710 is curved, uneven, has surface texture, or other form or shape. Surface 710 can have any shape, form, or surface texture according to the specific use of surface 710 in receiving layer of fluid 720. Layer of fluid 720 can take any form or shape on surface 710 according to the specific embodiment of apparatus 150. Layer of fluid 720 can be any fluid that is to be applied to any component 800. In some embodiments layer of fluid 720 and surface 710 take forms other than flat to conform to a particular component 800 or to apply a specific fluid. In some cases the fluid 720 does not adhere to component 800, but instead merely retains an imprint 740 of component 800.

Surface 710 in the embodiment of apparatus 150 shown in FIG. 5 is a part of a flat transparent plate 705. Plate 705 according to the invention does not need to be transparent. Plate 705 can be formed of any material or materials, and can be transparent, semi-transparent, or opaque according to its specific use in a pick and place machine.

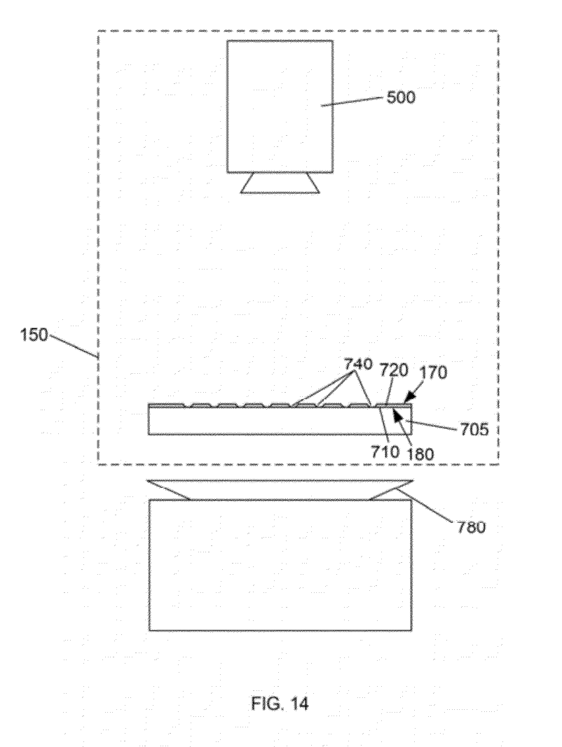

Camera 730 as shown in the embodiment of apparatus 150 in FIG. 5 is an upward looking camera that is positioned to capture an image as viewed from a bottom side 180 of layer of fluid 720. In some embodiments of apparatus 150 the camera 500, is a downward looking camera that is positioned to capture an image as viewed from a top side 170 of layer of fluid 720 (see FIG. 14). In some embodiments one or more than one camera is positioned to capture an image as viewed from both top side 170 and as viewed from bottom side 180 of layer of fluid 720 (see FIG. 11). The cameras do not need to be above or below layer of fluid 720 to capture these images. In some embodiments mirrors and/or optics are used to convey the image as viewed from top side 170 or as viewed from bottom side 180 of imprint 740 in layer of fluid 720 to one or more than one camera. In this way camera 730 can be positioned to capture an image of the imprint 740 in layer of fluid 720 from many different locations in pick and place machine 100.

Camera 730 of apparatus 150 according to the invention captures an image 732 of imprint 740 in layer of fluid 720. FIG. 6 through FIG. 10 show components 800 with different status and the resulting images 732 of imprint 740 that components 800 have left in layer of fluid 720 after component 800 was dipped in layer of fluid 720. Image 732 of layer of fluid 720 can be used in many ways by apparatus 150 and/or pick and place machine 100 in the component placement process according to the invention. Image 732 is used in some embodiments of the process according to the invention to determine where to place component 800. Image 732 can be analyzed by a processor in pick and place machine 100, or by a processor separate from pick and place machine 100. In some embodiments apparatus 150 includes a processor for analyzing images 732. The results of the analysis can be used to determine if component 800 should be placed on substrate 450 or not. In some embodiments an analysis of image 732 is used to determine that component 800 is properly placed on nozzle 220 and that component 800 is ready to be placed on substrate 450. In some embodiments an analysis of image 732 is used to determine that component 800 has fallen off of nozzle 220 and that nozzle 220 should go back to feeder 300 and pick another component 800. In some embodiments an analysis of image 732 is used to determine that component 800 is defective and that component 800 should be discarded instead of placed on substrate 450. In some embodiments an analysis of image 732 is used to determine the status of component 800, where the status can include such information as whether component 800 is aligned properly or rotated, if component 800 has properly placed interconnect elements 810, if an interconnect element 810 is missing, if all of the interconnect elements 810 received fluid, or any number of other status possibilities for component 800 that affect its placement on substrate 450. In some embodiments an analysis of image 732 is used to determine if pick and place machine 100 is aligned and how much it is out of alignment so that alignment corrections can be made. Image 732 can be analyzed and used in any number of different ways to help increase the quality and/or efficiency of pick and place machine 100.

FIGS. 6A-6B, depicts an embodiment of component 800 in which all bumps 810 are present and are not shifted. After dipping component 800, fluid is applied to all bumps 810 to create fluid-covered bumps 820 (FIG. 6A) and leaving imprint 740 in layer of fluid 720. Camera 730 captures image 732 of layer of fluid 720 as shown in FIG. 6B, which shows imprint 740 that is not shifted and has no voids. Analysis of image 732 can determine that component 800 is properly positioned for placement and that all interconnect elements 800 have been covered in solder flux, for example.

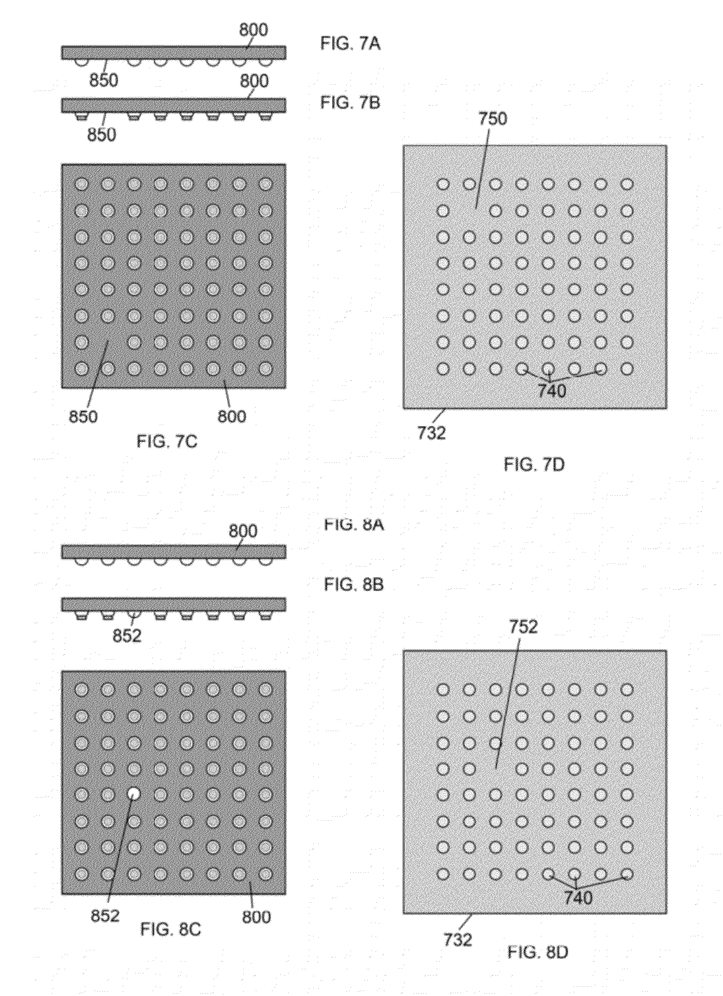

FIGS. 7A-7D, depict a situation where component 800 has a missing bump 850. Missing bump 850 is the position where component 800 is missing an interconnect element 810. Component 800 with missing bump 850 leaves an imprint 740 as shown in FIG. 7D. Image 732 as shown in FIG. 7D has missing interconnect imprint 750 where missing bump 850 leaves non-imprint 750. In this example analysis of image 732 can determine the status of component 800, in this case that component 800 may be missing an interconnect element. In this example component 800 may not be placed on substrate 450, and this placement decision would be made based on analyzing image 732 of imprint 740 in layer of fluid 720.

FIGS. 8A-8D show an example where not all of bumps 810 have had fluid applied to them. Shown is bump 852 which does not have any fluid on it after being dipped in layer of fluid 720. Image 732 shows non-imprint 752 where a bump 810 did not leave a void. Analyzing image 732 can determine the status of component 800, in this case that component 800 may have a bump that did not receive fluid.

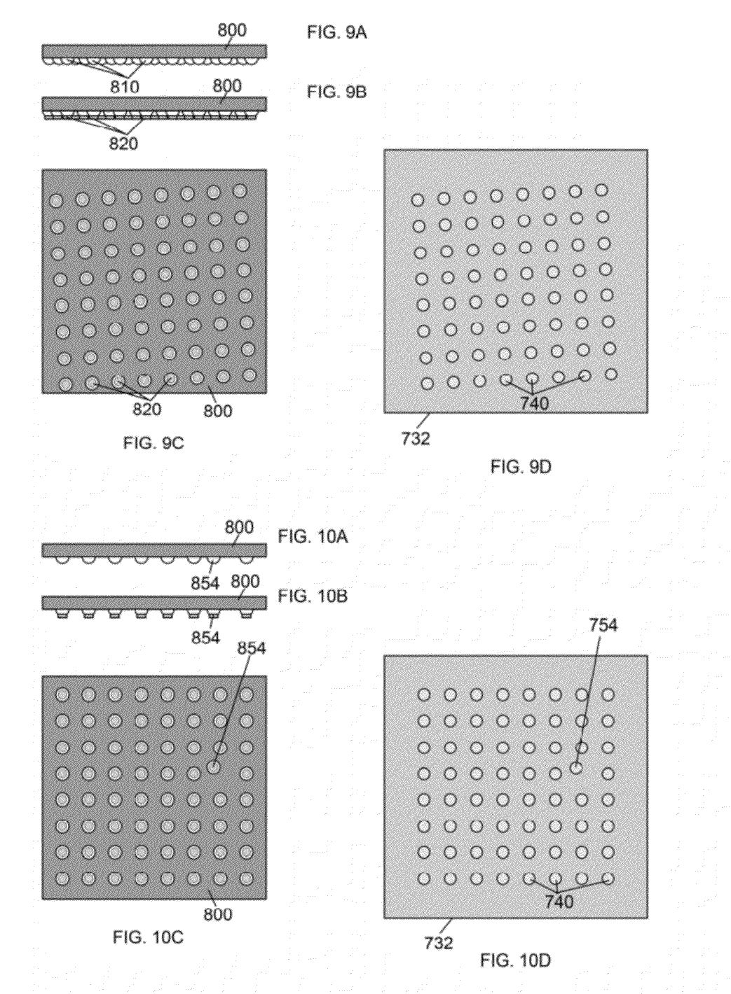

FIGS. 9A-9D show an embodiment of component 800 with bumps 810 rotated on component 800, thus leaving an imprint 740 that is rotated in fluid 720. Bumps 810 can be rotated, also called shifted or skewed, for many reasons. Bumps 810 can be rotated if, for example, they are not in alignment with respect to the component 800 package. Bumps 810 can be rotated if, for example, component 800 itself is rotated on pick and place vacuum spindle 210. What is important to pick and place machine 100 is that placement of component 800 occurs such that bumps 810 are aligned with their corresponding traces on substrate 450. Analysis of image 732 can determine that the status of component 800 is that bumps 810 are rotated or shifted, as well as whether an adjustment of pick and place head 200 can be used to align bumps 810 to their traces. This determination can be used to direct further placement of component 800. Component 800 can be placed on substrate 450 such that bumps 810 align with their corresponding traces, or component 800 can be not placed on substrate 450 because alignment of bumps to traces is not possible.

FIGS. 10A-10D, show another embodiment of component 800 in which component 800 has one shifted bump 854, thus leaving a corresponding shifted imprint 754 in fluid 720. Again, analysis of image 732 could determine that component 800 had one shifted bump 810 and further processing of component 800 could be directed accordingly.

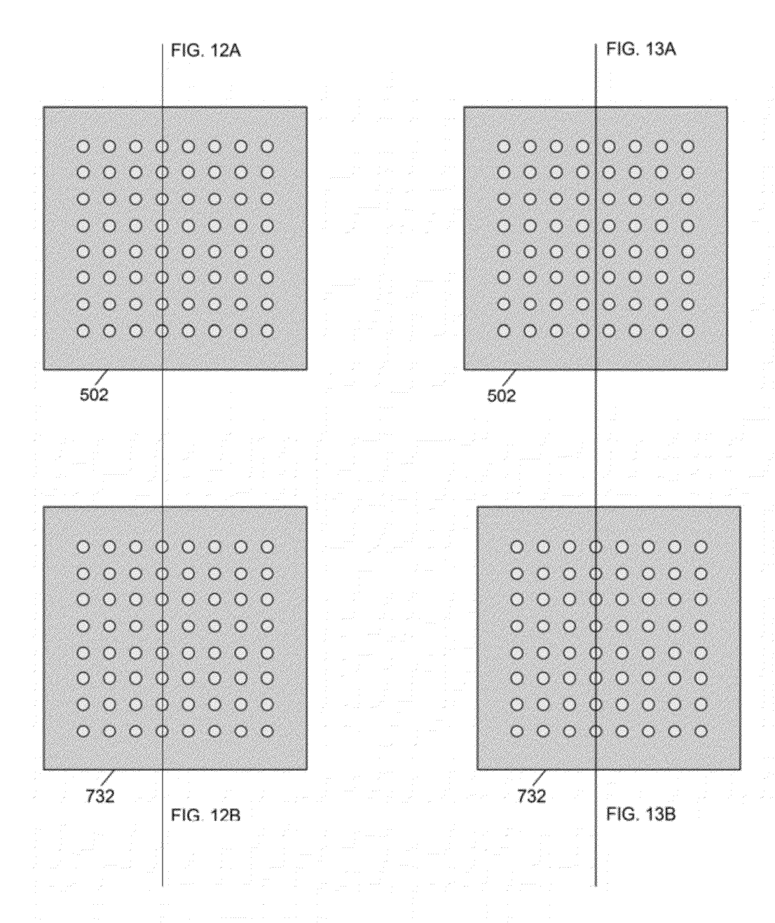

FIG. 11 shows a further embodiment of apparatus 150 according to the invention. In this embodiment apparatus 150 includes surface 710 of plate 705 which receives layer of fluid 720, imprint 740 of component 800 formed in layer of fluid 720 after component 800 is dipped in layer of fluid 720, downward looking camera 500, and upward looking camera 730. In this embodiment two cameras, downward looking camera 500, and upward looking camera 730, are positioned to capture an image of imprint 740 in layer of fluid 720, where layer of fluid 720 is on surface 710 of plate 705. Downward looking camera 500 captures image 502 (see FIG. 12) as viewed from top side 170 of imprint 740 in layer of fluid 720. Upward looking camera 730 captures image 732 as viewed from bottom side 180 of imprint 740 in layer of fluid 720. Image 732 and image 502 can be used in many different ways to increase the efficiency and/or accuracy of pick and place machine 100.

In one embodiment, image 502 as viewed from top side 170 of layer of fluid 720 and image 732 of as viewed from bottom side 180 of layer of fluid 720 are used to optimize the placement accuracy of machine 100 over time. Normally when component placement machine 100 warms up during production, the thermal compensation eliminates most of the effects of expansion of different parts of component placement machine 100. However, since this is a dynamic process, this compensation can not eliminate these effects completely. Periodically capturing an image of imprint 740 in layer of fluid 720 with downward looking camera 500 and at the same or almost same time, with upward looking camera 730 allows for significant improvement of the thermal compensation of machine 100, since this is a direct measurement of a deviation from the original calibration of machine 100. FIG. 12A depicts image 502 taken with downward looking camera 500 and FIG. 12B depicts image 732 taken with upward looking camera 730 in which imprint 740 in layer of fluid 720 as viewed by both cameras 500 and 730 are aligned. In contrast, FIGS. 13A-B depicts image 502 and image 732 in which imprint 740 in layer of fluid 720 as viewed by cameras 500 and 730 is not aligned, thus indicating a shift in component placement machine 100 alignment accuracy. Images 502 and 732 can be analyzed and used to determine the amount of thermal shift in machine 100, for example. This amount of shift can then be applied to subsequent moves of component placement machine 100 to restore the alignment and placement accuracy of component placement machine 100.

In another embodiment plate 705 may include an alignment reticle or fiducial mark (not shown) which then may be included in image 502 or image 732. The position of the fiducial line or mark in image 502 or 732 as compared to the position of imprint 740 in image 502 or 732 can be used to increase the placement accuracy of machine 100, or perform other calibration or alignment tasks.

FIG. 14 shows another embodiment of apparatus 150 according to the invention, where apparatus 150 may include light source 780. Light source 780 is used in this embodiment to illuminate layer of fluid 720 bottom side 180. Light source 780 can be used in various embodiments to illuminate either top side 170 or bottom side 180 of imprint 740 in layer of fluid 720. Light source 780 can be used in various embodiments to illuminate layer of fluid 720 from any position or location. In some embodiments light source 780 is used to improve the clarity of image 502 or 732. In some embodiments light source 780 is used to speed up the image capturing process, which will increase the speed of the pick and place process. Light source 780 can emit light with any wavelength and/or radiation characteristic as needed by apparatus 150 and camera 500 or 730. In some embodiments light source 780 emits white light. In some embodiments light source 780 emits light which has a wavelength characteristic designed to allow a specific analysis to be performed on image 732 or 502.

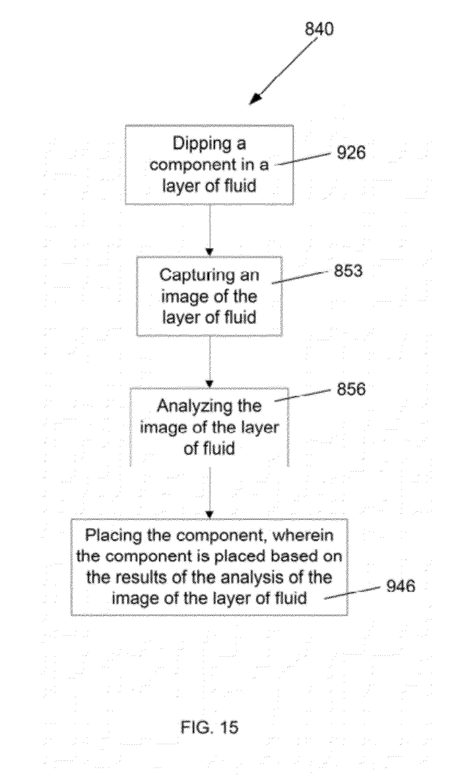

FIG. 15 shows method 840 according to the invention of placing a component with a pick and place machine. Method 840 includes step 926, dipping a component in a layer of fluid, step 853 capturing an image of the layer of fluid, step 856 analyzing the image of the layer of fluid, and step 946 placing the component, wherein the component is placed based on the results of the analysis of the image of the layer of fluid. Method 840 can include many other steps. In some embodiments method 840 includes the step of applying a layer of fluid to a surface. In some embodiments method 840 includes the step of determining the alignment status of the pick and place machine using the image of the layer of fluid. In some embodiments determining the alignment status of the pick and place machine using the image of the layer of fluid can include measuring an amount of alignment shift present in a pick and place head using the image of the layer of fluid and applying the amount of alignment shift to subsequent movement of the pick and place head.

Step 926 dipping a component in a layer of fluid involves dipping the component to be placed in any type of layer of any type of fluid. Often the component is dipped in the layer of fluid so that some of the fluid will be transferred to the component and/or the component interconnect elements. In some embodiments step 926 includes dipping a component in a layer of flux. In some embodiments step 926 includes dipping a component in a layer of adhesive. In some embodiments step 926 can includes dipping a component in a layer of solder paste. Step 926 can include other steps.

Step 853 capturing an image of the layer of fluid involves obtaining an image of the layer of fluid with a camera. Often the image is captured so that the image can be analyzed and used for a purpose in the pick and place process. Often the image is used to optimize the pick and place process. Step 853 capturing an image of the layer of fluid can include many other steps. In some embodiments capturing an image of the layer of fluid includes capturing an image of an imprint of a component in the layer of fluid, wherein the imprint resides in the layer of fluid after the component is dipped in the layer of fluid. In some embodiments step 853 include capturing an image as viewed from the top side of the layer of fluid. In some embodiments step 853 include capturing an image as viewed from the bottom side of the layer of fluid. In some embodiments step 853 include capturing an image as viewed from the top side of the layer of fluid and capturing an image as viewed from the bottom side of the layer of fluid.

Step 856 analyzing the image of the layer of fluid can include any type of analysis done with or on the image of the layer of fluid. The results of the analysis are often used to determine further placement actions of the placement machine. In some embodiments the analysis determines the status of the component. In some embodiments the analysis determines the status of the pick and place machine. Step 856 analyzing the image of the layer of fluid can include many other steps. In some embodiments the analysis determines the status of the layer of fluid. In some embodiments analyzing the image of the layer of fluid includes determining that fluid was not properly transferred to the component based on the analysis of the image of the layer of fluid. In some embodiments analyzing the image of the layer of fluid includes determining that the component is misaligned on a pick and place head. In some embodiments analyzing the image of the layer of fluid includes determining that the component is misaligned on a pick and place head by a misalignment amount. In some embodiments analyzing the image of the layer of fluid includes adjusting the alignment of the pick and place head by the misalignment amount. In some embodiments analyzing the image of the layer of fluid includes comparing an image as viewed from a top side of the layer of fluid to an image as viewed from a bottom side of the layer of fluid. In some embodiments analyzing the image of the layer of fluid includes determining the presence of a component on the end of a pick and place head. In some embodiments analyzing the image of the layer of fluid includes determining the size of a component on the end of a pick and place head. In some embodiments analyzing the image of the layer of fluid includes determining the position of a component on the end of a pick and place head. In some embodiments analyzing the image of the layer of fluid includes determining the presence of interconnect elements on a component. In some embodiments analyzing the image of the layer of fluid includes determining the position of interconnect elements on a component. In some embodiments analyzing the image of the layer of fluid includes determining the size of interconnect elements on a component. The analysis of the image of the layer of fluid can be used to provide any type of information about the component or the pick and place machine, often to allow the pick and place process to proceed quickly and without error.

Step 946 placing the component, wherein the component is placed base on the results of the analysis of the image of the layer of fluid, includes using the information obtained from the analysis of the image of the layer of fluid to guide the placement of the component. In some embodiments step 946 includes placing the component where it will be discarded. In this case the analysis of the image of the layer of fluid has determined that there is a problem with the component or with the fluid that was to be put on the component, and that the component should not be placed on the substrate. In some embodiments step 946 includes placing the component on a substrate. In this example the analysis of the image of the layer of fluid has determined that the component is properly placed on the end of the pick and place head, and that the fluid has been applied correctly, and that the component should be placed on the substrate. In some embodiments step 946 includes applying some rotation or adjustment to the component when placing the component. In this situation the analysis has determined that the component exists at the end of the pick and place head, but that it has been rotated by some amount. The pick and place head is told to apply a correcting rotation such that the component is placed on the substrate with no rotation. The analysis of the image of the layer of fluid can provide many types of information about the component and the placement machine. Step 946 placing the component involves applying the information received from the analysis of the image of the layer of fluid to execute component placement.

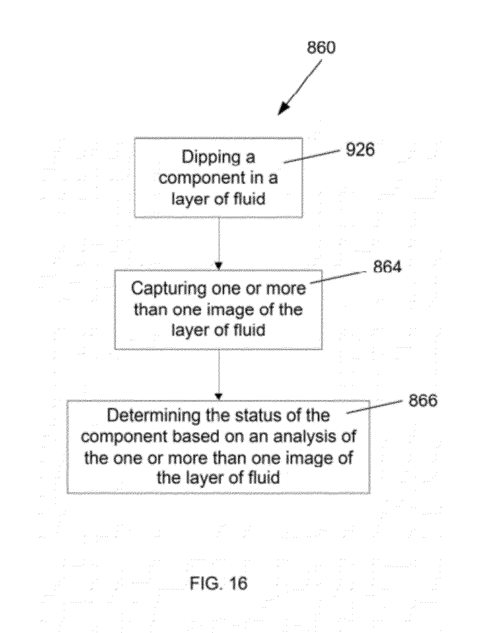

FIG. 16 shows method 860 of determining the status of a component in a pick and place machine according to the invention. Method 860 includes step 926 dipping a component in a layer of fluid, step 864 capturing one or more than one image of the layer of fluid, and step 866 determining the status of the component based on an analysis of the one or more than one image of the layer of fluid. Method 860 can include many other steps. In some embodiments method 860 includes determining the alignment status of the pick and place machine based on the analysis of the one or more than one image of the layer of fluid. In some embodiments determining the alignment status of the pick and place machine includes the step of comparing an image of a top side of the layer of fluid to an image of a bottom side of the layer of fluid.

Step 926 dipping a component in a layer of fluid involves dipping the component to be placed in any type of layer of any type of fluid, as discussed earlier with respect to method 840.

Step 864 capturing one or more than one image of the layer of fluid involves obtaining one or more than one image of the layer of fluid with a camera. Often the image or images are used to optimize or guide the pick and place process. Step 864 capturing one or more than one image of the layer of fluid can include many other steps. In some embodiments capturing one or more than one image of the layer of fluid includes capturing one or more than one image of an imprint of a component in the layer of fluid, wherein the imprint resides in the layer of fluid after the component is dipped in the layer of fluid. In some embodiments step 864 includes capturing one or more than one image as viewed from a top side of the layer of fluid. In some embodiments step 864 include capturing one or more than one image as viewed from a bottom side of the layer of fluid. In some embodiments step 864 includes capturing one or more than one image as viewed from the top side of the layer of fluid and capturing one or more than one image of the bottom side as viewed from the layer of fluid.

Step 866 determining the status of the component based on an analysis of the one or more than one image of the layer of fluid involves using the one or more than one images of the layer of fluid to obtain information about the component that is to be placed. This information can then be used to guide further actions in the placement process. In some embodiments determining the status of the component based on an analysis of the one or more than one image of the layer of fluid includes determining that fluid was not properly transferred to the component based on the analysis of the image of the layer of fluid. In some embodiments determining the status of the component based on an analysis of the one or more than one image of the layer of fluid includes determining that the component is misaligned on a pick and place head. In some embodiments determining the status of the component based on an analysis of the one or more than one image of the layer of fluid includes determining that the component is misaligned on a pick and place head by a misalignment amount. In some embodiments determining the status of the component based on an analysis of the one or more than one image of the layer of fluid includes adjusting the alignment of the pick and place head by the misalignment amount. In some embodiments determining the status of the component based on an analysis of the one or more than one image of the layer of fluid includes comparing an image as viewed from a top side of the layer of fluid to an image as viewed from a bottom side of the layer of fluid. In some embodiments determining the status of the component based on an analysis of the one or more than one image of the layer of fluid includes determining the presence of a component on the end of a pick and place head. In some embodiments determining the status of the component based on an analysis of the one or more than one image of the layer of fluid includes determining the size of a component on the end of a pick and place head. In some embodiments determining the status of the component based on an analysis of the one or more than one image of the layer of fluid includes determining the position of a component on the end of a pick and place head. In some embodiments determining the status of the component based on an analysis of the one or more than one image of the layer of fluid includes determining the presence of interconnect elements on a component. In some embodiments determining the status of the component based on an analysis of the one or more than one image of the layer of fluid includes determining the position of interconnect elements on a component. In some embodiments determining the status of the component based on an analysis of the one or more than one image of the layer of fluid includes determining the size of interconnect elements on a component. The analysis of the image of the layer of fluid can be used to provide any type of status information about the component or the pick and place machine, often to allow the pick and place process to proceed quickly and without error.

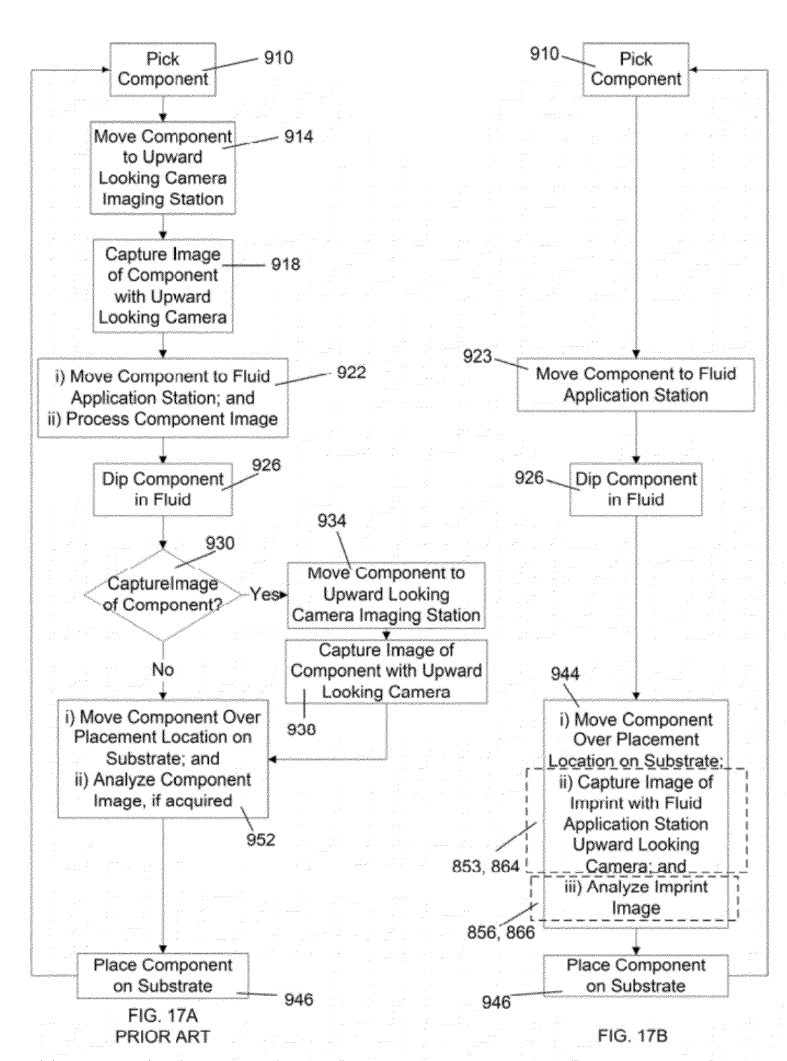

FIG. 17 shows how capturing the image of a layer of fluid after a component to be placed has been dipped in the fluid can improve the speed of the pick and place process. FIG. 17A shows a pick and place process flowchart which does not include capturing an image of a layer of fluid. The process includes step 910 pick a component, step 914 move the component over an upward looking camera, and step 918 capture an image of the component. Then step 922 includes moving the component to a fluid application station, and processing the captured image while moving. Once at the fluid application station step 926 dipping the component in fluid occurs. Step 930 includes determining if another captured image is necessary. If so, step 934 move the component over an upward looking camera occurs, and step 938 capture another image of the component. Then step 942 move the component over the placement location, and if an image was captured in step 938, process the additional captured image, occurs. Lastly step 946, place the component on substrate 450 occurs.

FIG. 17B shows an embodiment of a pick and place process according to the invention illustrating how the efficiency and/or accuracy of the placement process is improved. The improved process according to the invention as shown in FIG. 17B eliminates steps 914, 918, 930, 934, and 938, thus reducing the number of movements that the component placement machine must make between step 910 picking the component and step 946 placing the component. In the new process, after the component is picked in step 910, step 923 moving the component to the fluid application station and step 926 dipping the component occur. Step 944 includes moving the component to its placement station, and while the component is being moved to its placement location over the substrate, capturing one or more than one image of the layer of fluid with the fluid application station upward looking camera, and analyzing the image, where the image includes the imprint of the component, occur. Step 944 can include either or both of steps 853 or 864 discussed earlier with respect to method 840 and 860, and either or both of steps 856 or 866 as discussed earlier with respect to method 840 and 860. Then step 946 place component is executed. In this new process according to the invention not only are the number of steps reduced, and the number of movements of the pick and place head reduced, but the image capture of the layer of fluid and processing of the image of the layer of fluid can occur while the pick and place head with the component is moving to a new location. This reduces overall placement process time, while maintaining or increasing the accuracy of the process.

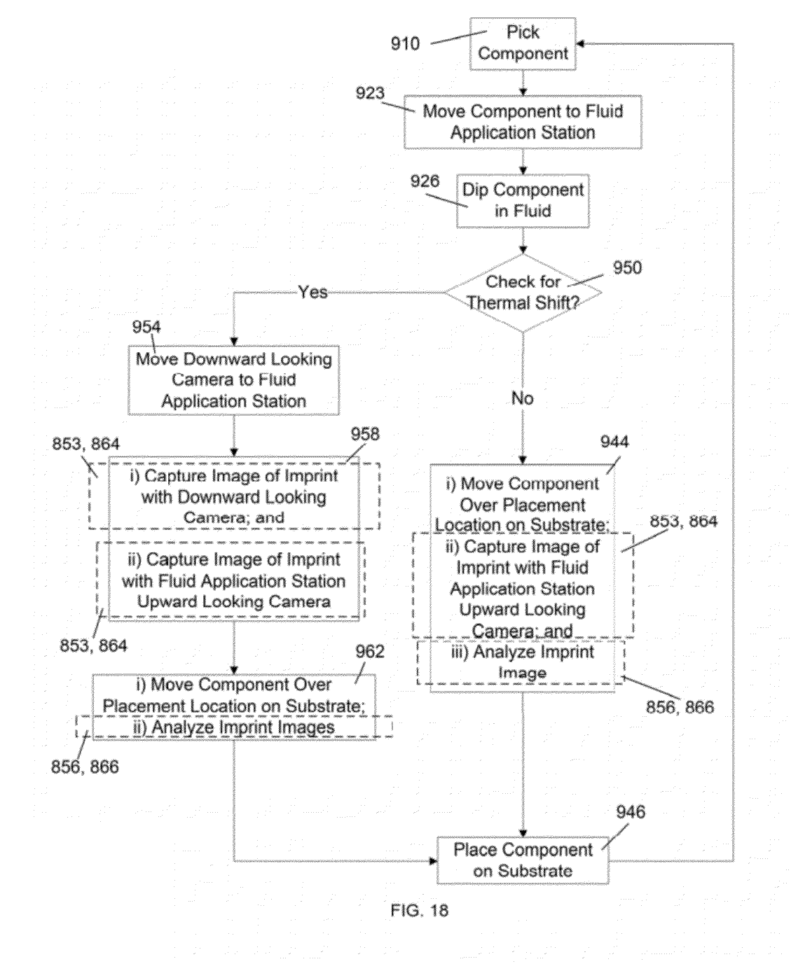

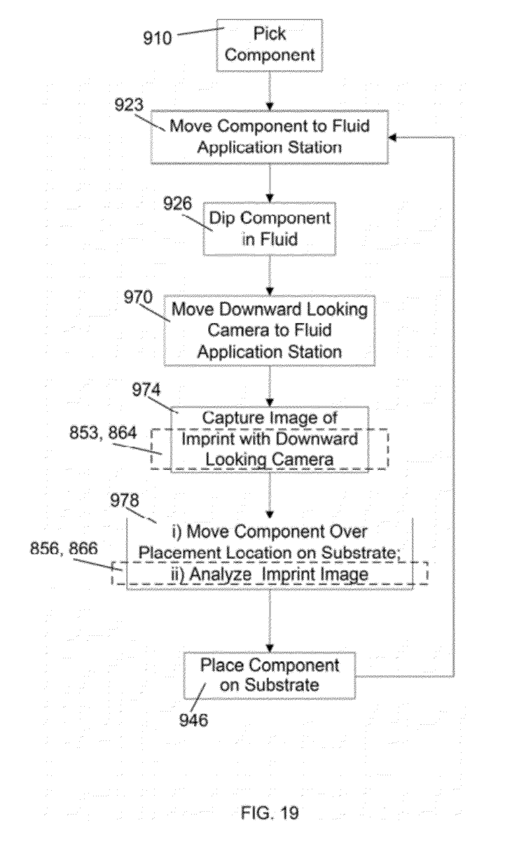

FIG. 18 shows another embodiment of a pick and place process according to the invention, which includes checking for thermal shift of the pick and place machine. In this scenario, if in step 950 it is decided to check for thermal shift of the pick and place machine, step 944 is replaced by step 954, step 958 and step 962. In step 954 the downward looking camera is moved to the fluid application station. In step 958, both the downward looking camera and the upward looking camera capture an image of the layer of fluid with the imprint of the component in it. In step 962, the component is moved to its placement location over the substrate while the captured images of the layer of fluid are analyzed. Finally, the component is placed in step 946. Step 958 can include either or both of steps 853 or 864 as discussed earlier with respect to method 840 and 860. Step 962 can include either or both of step 856 or step 866 discussed earlier with respect to method 840 and 860.

FIG. 19 shows an additional embodiment of a process according to the invention, where this process includes capturing an image of the layer of fluid with a downward looking camera. This process can be used if the fluid application station does not include an upward looking camera. In this scenario, a downward looking camera is relied on to capture an image of the imprint of the component for processing. This process includes step 910, 923, 926, and 946 as discussed earlier. After step 926, step 970 occurs, moving the downward looking camera to the fluid application station. In step 974 the downward looking camera captures an image of the layer of fluid that the component has been dipped in. Step 974 can include either or both of step 853 or step 864 as discussed earlier with respect to method 840 and method 860. Then in step 978, while moving the component to its position over the substrate, the captured image(s) are analyzed. Step 978 can include either or both of step 856 or step 866 as discussed earlier with respect to method 840 and method 860. In this process, the layer of fluid with the imprint is backlit by a light source housed underneath the surface that receives the layer of fluid at the fluid application station.

A new process and apparatus for placing components in a pick and place machine has been described. The new process can reduce placement time of the pick and place machine. The process and apparatus according to the invention includes capturing an image of the layer of fluid after a component has been dipped in the layer of fluid. The component leaves an imprint in the layer of fluid, and analysis of the image with the imprint can be used to determine the status of the component to be placed as well as the status of the pick and place machine itself. The image with the imprint of a component in it can be used to place the component, or to determine the status of the component or to determine information about the pick and place machine. The image of the imprint of a component can be used to obtain many type of information, and this information can be used to increase the speed and throughput of the pick and place machine without compromising the accuracy of the machine, but may improve the accuracy of the machine.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of placing a component with a pick and place machine, the method comprising:
dipping a component in a layer of fluid;
capturing an image of the layer of fluid;
analyzing the image of the layer of fluid;
and
placing the component, wherein the component is placed based on results of the analysis of the image of the layer of fluid.

2. The method of claim 1, wherein capturing an image of the layer of fluid comprises capturing an image of an imprint of the component, wherein the imprint of the component resides in the layer of fluid after the component is dipped in the layer of fluid.

3. The method of claim 1, wherein capturing an image of the layer of fluid comprises capturing an image as viewed from a top side of the layer of fluid and capturing an image as viewed from a bottom side of the layer of fluid.

4. The method of claim 1, wherein placing the component based on the results of the analysis of the image of the layer of fluid comprises placing the component where it will be discarded.

5. The method of claim 1, wherein analyzing the image of the layer of fluid comprises determining that fluid was not properly transferred to the component based on results of the analysis of the image of the layer of fluid.

6. The method of claim 1, further comprising determining the alignment status of the pick and place machine using the image of the layer of fluid.

7. The method of claim 6, wherein determining the alignment status of the pick and place machine using the image of the layer of fluid further comprises:
measuring an amount of alignment shift present in a pick and place head using the image of the layer of fluid;
and
applying the amount of alignment shift to subsequent movement of the pick and place head.

8. The method of claim 1, where the image of the imprint is captured while the component is dipped in the layer of fluid.

9. A method of determining the status of a component in a pick and place machine, the method comprising:
dipping a component in a layer of fluid;
capturing one or more than one image of the layer of fluid;
and
determining the status of the component based on an analysis of the one or more than one image of the layer of fluid.

10. The method of claim 9, wherein determining the status of the component based on an analysis of the one or more than one image of the layer of fluid further comprises:
determining that the component is misaligned on a pick and place head by a misalignment amount based on an analysis of the one or more than one image of the layer of fluid;
and
adjusting the alignment of the pick and place head by the misalignment amount.

11. The method of claim 9, wherein determining the status of the component based on an analysis of the one or more than one image of the layer of fluid comprises determining that the component is properly placed on the end of a pick and place head based on an analysis of the one or more than one image of the layer of fluid.

12. The method of claim 9, wherein determining the status of the component based on an analysis of the one or more than one image of the layer of fluid comprises determining that fluid was not properly transferred to the component based on an analysis of the one or more than one image of the layer of fluid.

13. The method of claim 9, further comprising determining the alignment status of the pick and place machine based on the analysis of the one or more than one image of the layer of fluid.

14. The method of claim 13, wherein determining the alignment status of the pick and place machine based on the analysis of the one or more than one image of the layer of fluid comprises comparing an image as viewed from a top side of the layer of fluid to an image as viewed from a bottom side of the layer of fluid.

15. An apparatus for capturing an image of a layer of fluid in a pick and place machine, the apparatus comprising:
a surface which receives a layer of fluid;
an imprint of a component formed in the layer of fluid after a pick and place head dips the component in the layer of fluid;
and
a camera positioned to capture an image of the imprint in the layer of fluid.

16. The apparatus of claim 15, wherein the camera is positioned to capture an image as viewed from a top side of the imprint in the layer of fluid.

17. The apparatus of claim 15, wherein the camera is positioned to capture an image as viewed from a bottom side of the imprint in the layer of fluid.

18. The apparatus of claim 15, further comprising a light source for illuminating the imprint in the layer of fluid.

19. The apparatus of claim 15, wherein the image of the imprint in the layer of fluid is used to determine an alignment status of the pick and place machine.

20. The apparatus of claim 19, wherein the image of the imprint in the layer of fluid is used to determine an alignment status of the pick and place machine based on comparing the image as viewed from a top side of the imprint in the layer of fluid to the image as viewed from a bottom side of the imprint in the layer of fluid.
